(19) United States
(12) Patent Application Publication
(10) Pub. No.: US 2008/0206417 A1
(43) Pub. Date: Aug. 28, 2008

(54) Sealable Laminate for Reclosable Packaging

(75) Inventors: Stefan Kirsch, Nieder-Olm (DE); Andree Dragon, Speyer (DE); Uta Holzenkamp, Lambsheim (DE); Cornelis Petrus Beyers, Altrip (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 11/995,877

(22) PCT Filed: Jul. 21, 2006
(86) PCT No.: PCT/EP06/64552

§ 371 Date: Jan. 16, 2008

(30) Foreign Application Priority Data
Jul. 28, 2005 (DE) 10 2005 035 979.5

(51) Int. Cl. B32B 27/06; B32B 27/32; B32B 27/36; B29C 65/52; B65D 77/12; B65D 81/133; B65D 33/16

(52) U.S. Cl. 426/394; 428/484.1; 428/480; 156/304.2; 426/392; 427/207.1; 383/42

(57) ABSTRACT

A multilayer laminate is composed of
a) a backing,
b) a pressure-sensitive adhesive layer applied directly to the backing, and
c) a wax layer applied directly to the pressure-sensitive adhesive layer.

The invention relates to a multilayer laminate composed of

a) a backing,
b) a pressure-sensitive adhesive layer applied directly to the backing, and
c) a wax layer applied directly to the pressure-sensitive adhesive layer.

The invention further relates to the use of said laminate as a component of reclosable packs, e.g. as a film lid, and to a method of producing the laminate.

Reclosable packs have been known for some time. With packs of this kind a tray that holds the packaged goods generally is durably sealed with a film lid. When the pack is opened it is not the seal layer which is torn open, but rather an overlying, weaker yet permanently tacky adhesive layer. The permanently tacky adhesive layer ensures repeatable opening and closing of the pack. WO 90/07427 and EP-A 1460117 describe reclosable packs which comprise a pressure-sensitive adhesive (PSA).

Film lids used at present generally have a highly complex multilayer construction. Atop a backing, of polyester for example, comes first an adhesive layer, generally of a hotmelt, followed by a migration barrier, which prevents the hotmelt migrating to adjacent layers, let alone coming into contact with the packaged goods. The layer construction is topped off with a sealable polyethylene layer (of high molecular weight polyethylene). Additionally, between the layers, it is generally necessary to have primer layers in order to improve the adhesion.

The tray intended for sealing with the film lid is composed in particular of a thermoformed polyester film, in particular of polyethylene terephthalate (PET), with a polyethylene seal layer.

PSAs used should as far as possible include those based on aqueous dispersions. Belgium patent BE 1010387 discloses the use of aqueous PSA dispersions for the adhesive layer. The seal layer on either side is composed in particular of polyvinylidene chloride (PVDC). Chlorinated compounds are unwanted for food packs. Seal layers comprising chlorinated polymers ought therefore to be avoided.

German patent application DE-A-10 2004 007 927.7, unpublished at the priority date of the present specification, discloses a process for multiple coating of substrates, using a multiple cascade die.

The desire in particular is for reclosable packaging systems with a simplified construction; a complex multilayer construction, particularly one involving migration barriers, as is usual for hotmelts, ought to be avoided. For the packing of comestibles there is a need for absence of odor, and volatile constituents ought as far as possible to be absent; chlorinated compounds should not be used. The tack should remain as high as possible even after repeated opening and closing of the pack.

The object of the invention is therefore odor-free reclosable packs, intended not least for comestibles, having a simplified construction and good long-term service properties, including in particular the possibility of effective sealing even after repeated opening, ideally without using chlorinated polymers.

Found accordingly have been the above-defined laminate and its use, and also a method of producing it.

The laminate is composed of

a) a backing,
b) a pressure-sensitive adhesive layer applied directly to the backing, and
c) a wax layer applied directly to the pressure-sensitive adhesive layer.

### The Backing

The backing is in particular a metal foil, such as aluminum foil, a polymer film, or a metallized polymer film, including in particular a composite film. Particular suitability is possessed by polymer films, more preferably transparent polymer films. Examples that may be mentioned include polyolefin, polyester or polyacetate films.

Examples of suitable polyolefin films include those of polyethylene or polypropylene, especially oriented polypropylene.

Preference is given to polyester films, such as those of phthalic or terephthalic esters, particular preference being given to films made of polyethylene terephthalate (PET).

The thickness of the backing is preferably 1 to 500 μm, more preferably 5 to 200 μm, very preferably 20 to 100 μm.

### The Pressure-Sensitive Adhesive Layer

Applied atop the backing is a pressure-sensitive adhesive (PSA) layer.

The PSA preferably comprises a synthetic polymer, in particular an emulsion polymer, as binder.

The polymer is in particular a polymer obtainable by free-radical polymerization of ethylenically unsaturated compounds (monomers), formed from at least 60% by weight of what are termed principal monomers, selected from C₁ to C₂₀ alkyl (meth)acrylates, vinyl esters of carboxylic acids comprising up to 20 carbon atoms, vinyl aromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and one or two double bonds, or mixtures of these monomers.

The polymer is composed preferably of at least 60%, in particular of at least 80%, and more preferably of at least 90% by weight of said principal monomers.

Examples include (meth)acrylic acid alkyl esters with a C₁-C₁₀ alkyl radical, such as methyl methacrylate, methyl acrylate, n-butyl acrylate, ethyl acrylate and 2-ethylhexyl acrylate.

Also suitable in particular are mixtures of the (meth)acrylic acid alkyl esters.

Vinyl esters of carboxylic acids having 1 to 20 carbon atoms are, for example, vinyl laurate, vinyl stearate, vinyl propionate, Versatic acid vinyl esters, and vinyl acetate.

Suitable vinyl aromatic compounds include vinyl toluene, a- and p-methylstyrene, a-butylstyrene, 4-n-butylstyrene, 4-n-decylstyrene, and, preferably, styrene. Examples of nitriles are acrylonitrile and methacrylonitrile.

The vinyl halides are chloro-, fluoro- or bromo-substituted ethylenically unsaturated compounds, preferably vinyl chloride and vinylidene chloride.

Examples of vinyl ethers include vinyl methyl ether or vinyl isobutyl ether. Preference is given to vinyl ethers of alcohols comprising 1 to 4 carbon atoms.

As hydrocarbons having 4 to 8 carbon atoms and two olefinic double bonds mention may be made of butadiene, isoprene, and chloroprene.

Preferred principal monomers are the C₁ to C₁₀ alkyl acrylates and methacrylates, particularly C₁ to C₈ alkyl acrylates and methacrylates, and vinyl aromatics, particularly styrene, and mixtures thereof.

Very particular preference is given to methyl acrylate, methyl methacrylate, ethyl acrylate, n-butyl acrylate, n-hexyl acrylate, octyl acrylate and 2-ethylhexyl acrylate, styrene, and mixtures of these monomers.

In particular the polymer is formed from at least 60%, more preferably at least 80%, and very preferably at least 95% by weight of C₁ to C₂₀ alkyl (meth)acrylates.

Besides the principal monomers the polymer may comprise further monomers, examples being monomers having carboxylic acid, sulfonic acid or phosphonic acid groups. Carboxylic acid groups are preferred. Examples include acrylic acid, methacrylic acid, itaconic acid, maleic acid or fumaric acid.

Further monomers are, for example, monomers also comprising hydroxyl groups, particularly C₁-C₁₀ hydroxyalkyl (meth)acrylates, and (meth)acrylamide.

Further monomers additionally include phenyloxyethyl glycol mono(meth)acrylate, glycidyl acrylate, glycidyl methacrylate, and amino (meth)acrylates such as 2-aminoethyl (meth)acrylate.

As further monomers mention may also be made of crosslinking monomers.

The polymer may in particular comprise hydrophilic groups selected from carboxylic acid groups, hydroxyl groups, amino groups, and carboxamide groups. The amount of these hydrophilic groups may in particular be 0.001 to 0.5 mol per 100 g of polymer. The amount is more preferably at least 0.005 mol, very preferably at least 0.008 mol, and at most 0.2 mol, in particular at most 0.1 mol, very preferably at most 0.05 or 0.03 mol, per 100 g/polymer.

With particular preference the hydrophilic groups are selected from carboxylic acid groups, hydroxyl groups, and carboxamide groups. Carboxylic acid groups are particularly preferred.

Carboxylic acid groups also include salts of the carboxylic acid groups. In the case of the salts they are preferably salts with volatile bases, ammonia for example.

The hydrophilic groups can be attached to the polymer by copolymerizing the corresponding monomers.

Preferred monomers with hydrophilic groups are the abovementioned monomers having carboxylic acid groups and hydroxyl groups, particularly, for example, acrylic acid.

In one preferred embodiment the polymers are prepared by emulsion polymerization, and the product is therefore an emulsion polymer in the form of an aqueous polymer dispersion.

In the course of the emulsion polymerization ionic and/or nonionic emulsifiers and/or protective colloids or stabilizers are used as surface-active compounds.

A detailed description of suitable protective colloids can be found in Houben-Weyl, Methoden der organischen Chemie, volume XIV/1, Makromolekulare Stoffe [Macromolecular Compounds], Georg-Thieme-Verlag, Stuttgart, 1961, pp. 411 to 420. Suitable emulsifiers include anionic, cationic, and nonionic emulsifiers. As accompanying surface-active substances it is preferred to use exclusively emulsifiers, whose molecular weights, unlike those of the protective colloids, are normally below 2000 g/mol. Where mixtures of surface-active substances are used the individual components must of course be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO units: 3 to 50, alkyl: C₈ to C₃₆), ethoxylated mono-, di- and tri-alkylphenols (EO units: 3 to 50, alkyl: C₄ to C₉), alkali metal salts of dialkyl esters of sulfosuccinic acid, and also alkali metal salts and ammonium salts of alkyl sulfates (alkyl: C₈ to C₁₂), of ethoxylated alkanols (EO units: 4 to 30, alkyl: C₁₂ to C₁₈), of ethoxylated alkylphenols (EO units: 3 to 50, alkyl: C₄ to C₉), of alkylsulfonic acids (alkyl: C₁₂ to C₁₈), and of alkylarylsulfonic acids (alkyl: C₉ to C₁₈).

Further suitable emulsifiers are compounds of the general formula II

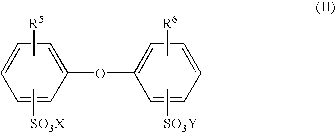

in which R⁵ and R⁶ are hydrogen or C₄ to C₁₄ alkyl but are not simultaneously hydrogen, and X and Y can be alkali metal ions and/or ammonium ions. With preference, R⁵ and R⁶ are linear or branched alkyl radicals having 6 to 18 carbon atoms or hydrogen, and in particular having 6, 12, and 16 carbon atoms, R⁵ and R⁶ not both simultaneously being hydrogen. X and Y are preferably sodium, potassium or ammonium ions, sodium being particularly preferred. Particularly advantageous compounds II are those in which X and Y are sodium, R⁵ is a branched alkyl radical having 12 carbon atoms, and R⁶ is hydrogen or R⁵. Use is frequently made of technical-grade mixtures containing a fraction of from 50 to 90% by weight of the monoalkylated product, an example being Dowfax® 2A1 (trademark of the Dow Chemical Company).

Suitable emulsifiers can also be found in Houben-Weyl, Methoden der organischen Chemie, volume 14/1, Makromolekulare Stoffe, Georg Thieme Verlag, Stuttgart, 1961, pages 192 to 208.

Examples of emulsifier trade names include Dowfax® 2 A1, Emulan® NP 50, Dextrol® OC 50, Emulgator 825, Emulgator 825 S, Emulan® OG, Texapon® NSO, Nekanil® 904 S, Lumiten® I-RA, Lumiten® E 3065, Disponil® FES 77, Lutensol® AT 18, Steinapol VSL, and Emulphor NPS 25.

For the present invention preference is given to ionic emulsifiers or protective colloids. With particular preference they are ionic emulsifiers, in particular salts and acids, such as carboxylic acids, sulfonic acids, and sulfates, sulfonates or carboxylates.

The surface-active substance is typically used in amounts of 0.1 to 10 parts by weight, preferably 0.2 to 5 parts by weight, per 100 parts by weight of the monomers to be polymerized.

Water-soluble initiators for the emulsion polymerization are, for example, ammonium salts and alkali metal salts of peroxodisulfuric acid, e.g., sodium peroxodisulfate, hydrogen peroxide, or organic peroxides, e.g., tert-butyl hydroperoxide.

Also suitable are what are called reduction-oxidation (redox) initiator systems.

The redox initiator systems are composed of at least one, usually inorganic reducing agent and one organic or inorganic oxidizing agent.

The oxidizing component comprises, for example, the emulsion polymerization initiators already mentioned above.

The reducing component comprises, for example, alkali metal salts of sulfurous acid, such as sodium sulfite, sodium hydrogensulfite, alkali metal salts of disulfurous acid such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems may be used together with soluble metal compounds whose metallic component is able to exist in a plurality of valence states.

Examples of customary redox initiator systems include ascorbic acid/iron(II) sulfate/sodium peroxodisulfate, tert-butyl hydroperoxide/sodium disulfite, and tert-butyl hydroperoxide/Na hydroxymethanesulfinate. The individual components, the reducing component for example, may also be mixtures: for example, a mixture of the sodium salt of hydroxymethanesulfinic acid with sodium disulfite.

The compounds stated are mostly used in the form of aqueous solutions, the lower concentration being determined by the amount of water that is acceptable in the dispersion and the upper concentration by the solubility of the respective compound in water. The concentration is generally 0.1% to 30% by weight, preferably 0.5% to 20% by weight, more preferably 1.0% to 10% by weight, based on the solution.

The amount of the initiators is generally 0.1% to 10% by weight, preferably 0.5% to 5% by weight, based on the monomers to be polymerized. It is also possible for two or more different initiators to be used in the emulsion polymerization.

For the polymerization it is possible to use regulators, in amounts for example of from 0 to 0.8 part by weight, per 100 parts by weight of the monomers to be polymerized. These regulators lower the molar mass. Suitable examples include compounds containing a thiol group, such as tert-butyl mercaptan, thioglycolic acid ethylacrylic ester, mercaptoethynol, mercaptopropyltrimethoxysilane, and tert-dodecyl mercaptan.

The emulsion polymerization takes place in general at 30 to 130° C., preferably 50 to 90° C. The polymerization medium may be composed either of water alone or of mixtures of water with water-miscible liquids such as methanol. It is preferred to use just water. The emulsion polymerization may be conducted either as a batch operation or in the form of a feed process, including staged or gradient procedures. Preference is given to the feed process, in which a portion of the polymerization mixture is introduced as an initial charge and heated to the polymerization temperature, the polymerization of this initial charge is begun, and then the remainder of the polymerization mixture is supplied to the polymerization zone, usually by way of two or more spatially separate feed streams, of which one or more comprise the monomers in neat form or emulsified form, this addition being made continuously, in stages or under a concentration gradient, and polymerization being maintained during said addition. It is also possible, in order for example to set the particle size more effectively, to include a polymer seed in the initial charge for the polymerization.

The manner in which the initiator is added to the polymerization vessel in the course of the free-radical aqueous emulsion polymerization is known to the skilled worker. It may either be included in its entirety in the initial charge to the polymerization vessel or else introduced, continuously or in stages, at the rate at which it is consumed in the course of the free-radical aqueous emulsion polymerization. In each specific case this will depend both on the chemical nature of the initiator system and on the polymerization temperature. It is preferred to include one portion in the initial charge and to supply the remainder to the polymerization zone at the rate at which it is consumed.

In order to remove the residual monomers it is common to add initiator after the end of the actual emulsion polymerization as well, i.e., after a monomer conversion of at least 95%.

With the feed process, the individual components can be added to the reactor from the top, through the side, or from below, through the reactor base.

In the case of emulsion polymerization, aqueous polymer dispersions with solids contents generally of 15% to 75% by weight are obtained, preferably of 40% to 75% by weight.

For a high reactor space/time yield, dispersions with as high as possible a solids content are preferred. In order to be able to achieve solids contents >60% by weight, a bimodal or polymodal particle size ought to be set, since otherwise the viscosity becomes too high and the dispersion can no longer be handled. Producing a new generation of particles can be done, for example, by adding seed (EP 81083), by adding excess quantities of emulsifier, or by adding miniemulsions. Another advantage associated with the low viscosity at a high solids content is the improved coating behavior at high solids contents. One or more new generations of particles can be produced at any point in time. It is guided by the particle size distribution which is targeted for a low viscosity.

The polymer thus prepared is used preferably in the form of its aqueous dispersion.

The average particle size of the polymer particles dispersed in the aqueous dispersion is preferably less than 400 nm, in particular less than 200 nm. With particular preference the average particle size is between 140 and 200 nm.

This average particle size is the d₅₀ value of the particle size distribution: that is, 50% by weight of the total mass of all particles have a diameter smaller than the d₅₀ value. The particle size distribution can be determined in a conventional manner using an analytical ultracentrifuge (W. Mächtle, Makromolekulare Chemie 185 (1984), page 1025-39).

The pH of the polymer dispersion is preferably set to a value of more than 4.5, in particular to between 5 and 8.

The glass transition temperature of the polymer, or of the polymer, is preferably from −60 to 0° C., more preferably from −60 to −10° C., and very preferably from −60 to −20° C.

The glass transition temperature can be determined by customary methods such as differential thermoanalysis or differential scanning calorimetry (see, for example, ASTM 3418/82, midpoint temperature).

The PSAs may be composed solely of the polymer or of the aqueous polymer dispersion.

The PSA may comprise further additives, e.g., fillers, colorants, flow control agents, thickeners or tackifiers (tackifying resins).

Examples of tackifiers include natural resins, such as rosins and their derivatives formed by disproportionation or isomerization, polymerization, dimerization, hydrogenation. They may be present in their salt form (with, for example, monovalent or polyvalent counterions (cations)) or, preferably, in their esterified form. Alcohols used for the esterification may be monohydric or polyhydric. Examples are methanol, ethanediol, diethylene glycol, triethylene glycol, 1,2,3-propanethiol, and pentaerythritol.

Also used are hydrocarbon resins, e.g., coumarone-indene resins, polyterpene resins, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene.

Other compounds increasingly being used as tackifiers include polyacrylates which have a low molar weight. These polyacrylates preferably have a weight-average molecular weight M_{w} of less than 30 000. With preference the polyacrylates are composed of at least 60% by weight, in particular at least 80% by weight, of C₁-C₈ alkyl (meth)acrylates.

Preferred tackifiers are natural or chemically modified rosins. Rosins are composed predominantly of abietic acid or its derivatives.

The amount by weight of the tackifiers is preferably 0 to 100 parts by weight, more preferably 0 to 50 parts by weight, per 100 parts by weight of polymer (solids/solids).

Preferably the PSA may comprise flow control agents (e.g., Lumiten), in amounts of 0.05 to 3 parts by weight per 100 parts by weight of polymer, for example.

For use in reclosable packs the PSA must not have too great an internal strength (cohesion). When the pack is first opened, rupture should occur as far as possible in the middle of the PSA layer (cohesive fracture), so that thereafter both the film lid and the tray edge are coated with PSA and, accordingly, the possibility of effective reclosure is ensured.

The cohesion and adhesion of the PSA can be adjusted through the selection of suitable polymers and, if appropriate, suitable additives, particularly tackifiers, such that cohesive fracture occurs.

The shear strength, as a measure of the cohesion, is determined by the test below, in hours, and is preferably less than 5 hours.

The peel strength, as a measure of the adhesion, is determined by the test below, and is preferably greater than 10 N/25 mm.

For determination of the shear strength and peel strength, the aqueous PSA is applied to a polyethylene film at a rate of 20 g (solids, excluding water)/m2 and dried at 90° C. for 3 minutes.

For the determination of the shear strength, test strips with a width of 25 mm are adhered to a chromed V2A steel test panel (bonded area 25 mm2), rolled on once with a roller weighing 1 kg, stored for 10 minutes (under standard conditions, 1 bar, 21° C.), and then loaded in suspension with a 0.5 kg weight (under standard conditions, 1 bar, 21° C.). The measure of the shear strength is the time taken for the weight to fall off; the average is taken from 5 measurements.

For the determination of the peel strength, test strips with a width of 25 mm are adhered to a chromed V2A steel test panel (bonded area 25 mm2), rolled on once with a roller weighing 1 kg, stored for 10 minutes (under standard conditions, 1 bar, 21° C.), and then clamped by one end into the upper jaws of a tension-elongation testing apparatus. The test strips are peeled from the test area at 300 mm/min and at an angle of 180°, and the force required to do this is measured. The measure of the peel strength is the force in N/2.5 cm which resulted as the average value from five measurements.

To produce the PSA layer on the backing, the backing material can be coated in typical fashion. Typical application rates (after drying) are, for example, 1 to 50 g PSA (dry, excluding water)/m².

### The Wax Layer

Applied atop the PSA, as a further layer, is a wax layer.

Suitable waxes include, in particular, paraffin waxes and polyethylene waxes.

By paraffin waxes (a term which should be taken to include isoparaffins as well) are meant, in particular, paraffins which are solid at room temperature and melt in the range of 50 to 80° C., preferably 60 to 75° C.; in other words, they are saturated hydrocarbons, branched or unbranched, cyclic or, preferably acyclic, individually or, preferably, as a mixture of two or more saturated hydrocarbons. Paraffin waxes are preferably saturated hydrocarbons having 18 to 60 carbon atoms.

A polyethylene wax is a polymer composed preferably of at least 30%, in particular of at least 50%, and more preferably of at least 60% or even 70% by weight of ethylene.

Besides ethylene the polyethylene wax may comprise further monomers as components of its structure.

Examples include olefins such as propylene, 1-butene, 1-pentene, 1-hexene, 1-octene or 1-decene, or the principal or further monomers already mentioned above.

Preference is given to polyethylene waxes containing polar groups, especially hydroxyl groups, amino groups, acid groups or salt groups.

The polyethylenes preferably comprise acid groups, particularly carboxylic acid groups.

Polar groups, particularly acid groups, can be introduced into the polyethylene by means of copolymerization with corresponding monomers.

Particularly suitable are monocarboxylic or dicarboxylic acids such as acrylic acid, methacrylic acid or maleic acid.

The presence of polar groups, carboxylic acid groups for example, in the polyethylene may alternatively be brought about by means of subsequent, polymer-analogous reaction, such as oxidation with oxygen, for example.

The polyethylene wax preferably has a polar groups content (see above), in particular an acid groups content, more preferably carboxylic acid groups, of 0.01 to 1 mol per 100 g of polyethylene; more preferably the amount is at least 0.2 mol per 100 g of polyethylene. The amount generally does not exceed 0.8 mol, or 0.6 mol, per 100 g.

The polyethylene wax preferably has a weight-average molecular weight Mw of 1000 to 40 000 g/mol, in particular of 1000 to 20 000 g/mol, more preferably of 3000 to 18 000 g/mol, and very preferably of 5000 to 15 000 g/mol (as determined by means of gel permeation chromatography).

The polyethylenes preferably have a density of 0.8 to 1.0 g/cm3, more preferably of 0.90 to 0.96 g/cm3, and very preferably of 0.93 to 0.95 g/cm3, as measured at 23° C. The melt viscosities are preferably in the range from 20 to 20 000 centistokes (cSt), more preferably in the range from 800 to 2000 cSt, as measured at 120° C., corresponding to a molecular weight Mw of not more than 40 000 g, preferably not more than 10 000 g, and more preferably not more than 7500 g. The molecular weight distribution is located preferably in the range from 2 to 10. The melting points lie preferably in the range from 60 to 125° C., more preferably 80 to 120° C.

Polyethylene waxes are prepared by polymerizing or copolymerizing ethylene.

The preparation processes can be subdivided, very roughly, into low-pressure processes, conducted at 20 to 100 bar, and high-pressure processes, conducted at 500 to 4000 bar. The high-pressure process is a free-radical polymerization process which generally is accomplished without catalyst. To initiate the free-radical chain reaction it is common to use one or more organic peroxides, examples being the Trigonox□ or Perkadox□ brands from Akzo Nobel, or else air or atmospheric oxygen. The cheapest and hence most widespread free-radical initiator is air or atmospheric oxygen.

To set the appropriate molecular weight it is possible to use suitable molecular weight regulators.

One regulator frequently used is hydrogen, although if air or atmospheric oxygen is used as free-radical initiator this can lead to the formation of oxyhydrogen gas, and so gives rise to concerns on safety grounds.

Further regulators frequently used are carbon monoxide, CO, and alkanes such as ethane or propane, for example. Carbon monoxide is highly toxic, and so costly and inconvenient safety measures are needed when using it. Regulators in gas form such as ethane and propane likewise necessitate strict safety regulations.

The polyethylene waxes are used preferably in the form of a solution or dispersion, more preferably in the form of an aqueous solution or dispersion.

Where the polar groups content is not sufficient for dispersion of the polyethylene, emulsifiers and protective colloids can be used as well. Suitable examples include the abovementioned emulsifiers and protective colloids.

The wax is preferably in the form of a solution or dispersion, more preferably an aqueous solution or dispersion.

To produce the wax layer the wax, or the solution or dispersion, can be applied in typical fashion to the PSA layer. The thickness of the wax layer ought to be sufficient to cover the underlying PSA, so that the outer layer is nonblocking and the thickness of the wax layer is sufficient for subsequent sealing. Application rates sufficient for this purpose are (after drying) in general from 1 to 50 g wax (dry, excluding water)/m², more preferably from 1 to 20 g wax/m², very preferably 1 to 10 g wax/m².

### The Production of the Laminate

The PSA layer is produced preferably by coating the backing with the aqueous PSA, preferably in the form of a PSA dispersion, i.e., a polymer dispersion of the kind obtainable in emulsion polymerization and, if appropriate, comprising further additives, as set out above.

The wax layer as well is produced preferably by coating with an aqueous wax dispersion.

Between the production of the PSA layer and of the wax layer there may be an intermediate drying operation, although a drying step of this kind is not necessary.

Advantageously the PSA layer and the wax layer can be produced wet on wet; in other words, no drying takes place after the coating of the dispersion of pressure-sensitive adhesive, which is followed immediately by coating with the wax dispersion.

In particular the PSA layer and the wax layer can be applied in one workstep. In this case a backing in web form can be coated continuously, and in this case it is possible in particular to use a multiple cascade die, as described in DE-A-10 2004 007 927.7.

### The Use of the Laminate

The multilayer laminate may be used as a sealable component of a packaging system, as a film lid for example, particularly for reclosable packs.

The laminate of the invention is preferably sealable with polyethylene, and the laminate is therefore used with preference to seal a tray which has a polyethylene seal layer.

Sealable means that the multilayer substrate can be joined to another substrate. In general such joining (sealing) is performed with elevated pressure and/or elevated temperature.

In particular the further substrate, at least in those areas where joining to the laminate is to take place, i.e., at the sealing seam, has an outer coating of polyethylene, in particular of high molecular weight, thermoplastic polyethylene. The polyethylene in this case is, in particular, not a polyethylene wax but rather a high molecular weight polyethylene. The weight-average molar weight, Mw, is in particular greater than 100 000 and more preferably greater than 500 000.

Sealing, i.e., the pressing together of the two substrates, is accomplished preferably at a pressure of 1 to 20 bar, more preferably of 1 to 5 bar, with the temperature being in particular 30 to 200° C., more preferably 70 to 120° C., for a time of, in particular, 0.5 to 5 seconds, in particular 1 to 2 seconds.

The further substrate is in particular an open container (tray) made of any desired material, plastic for example, in particular, for example, of polyester, PET for example, which is coated in the areas intended for sealing, particularly at the edge, with polyethylene.

Trays of this kind are generally produced by thermoforming an appropriate film, an example being a polyethylene-coated polyester film.

It is also possible, conversely, for the tray to be formed of the multilayer laminate and for the film lid for sealing to have a coating of high molecular weight polyethylene.

The multilayer laminate is used preferably for packaging products, particularly for sealing a tray that holds the products and has a sealable seam of polyethylene.

The products are, in particular, comestibles, examples being meat products, sausage products or cheese products.

The packs produced with the laminate of the invention are reclosable. When the pack is first opened it is not the sealing seam but instead the weaker PSA layer that tears. Preferably there is cohesive fracture in the PSA layer. The PSA layer does not come apart at one of the interfaces; instead, separation occurs within the PSA layer, so that thereafter the outerfaces of both parted substrates are coated with PSA. In this case both surfaces are tacky.

The pack is reclosable a great number of times, with virtually no decrease in strength after repeated closing.

The laminates have a simple layer construction, are odor-free, and are substantially free from volatile constituents. They are suitable for packaging comestibles. There is no need to use chlorinated compounds in the laminates or packaging systems. The laminates are heat-sealable. They are suitable as film lids for reclosable packs. When the pack is opened, there is, in particular, a cohesive fracture in the PSA layer. The pack can be opened and closed a very great number of times, with the capacity for effective reclosure.

### EXAMPLES

### Pressure-Sensitive Adhesive

The pressure-sensitive adhesive used was Acronal® V 115, a polyacrylate dispersion from BASF.

### Polyethylene Wax

The polyethylene wax used was an aqueous dispersion of an ethylene/acrylic acid copolymer, available as Epotal® DS 2343 from BASF.

### Production of the Laminate

A polyester film (polyethylene terephthalate, PET, Hostafan BN 50) with a thickness of 51 μm was coated with 20 g of pressure-sensitive adhesive (solids, excluding water) and dried at 90° C. for 3 minutes.

Thereafter the aqueous polyethylene dispersion was coated (3 g dry/m2) followed likewise by drying at 90° C. for 3 minutes.

The layer structure of the laminate was therefore as follows:

Top film (PET, Hostafan BN 50, 51 μm)
Acronal® V 115, 20 g/m²
Epotal® 2343, 3 g/m²

### Testing of the Coated Laminate for Sealability and Reclosability:

The outcome is a clear laminate which is blocking-resistant on the winding side. This laminate was heat-sealed with a 300μ PET film (laminated to a PE film). Sealing conditions were as follows: 6 bar, 1.5 s, 120° C. (tray side)/80° C. (lid side).

The sealed assembly thus produced was subjected to a separation test. For this test the heat-sealed strips were separated repeatedly with a take-off speed of 300 mm/min, and rebonded using a 2 kg roller at a speed of 10 mm/s. The bonding values found were as follows:

| Attempt | Measurement | Fracture mode |
|---|---|---|
| 1st separation | 6.75 N/25 mm | cohesive |
| 2nd separation | 1.25 N/25 mm | cohesive |
| 3rd separation | 1 N/25 mm | cohesive |
| 4th separation | 1 N/25 mm | cohesive |
| 5th separation | 0.75 N/25 mm | cohesive |
| 6th separation | 1 N/25 mm | cohesive |
| 7th separation | 0.75 N/25 mm | cohesive |
| 8th separation | 0.75 N/25 mm | cohesive |
| 9th separation | 0.5 N/25 mm | cohesive |
| 10th separation | 0.5 N/25 mm | cohesive |

1: A multilayer laminate composed of
a) a backing,
b) a pressure-sensitive adhesive layer applied directly to the backing, and
c) a wax layer applied directly to the pressure-sensitive adhesive layer.

2: The multilayer laminate according to claim 1, wherein said backing is a transparent polymer film, metal foil or metallized polymer film.

3: The multilayer laminate according to claim 1, wherein said backing is a polyolefin or polyester film.

4: The multilayer laminate according to claim 1, wherein the pressure-sensitive adhesive of layer b) comprises an emulsion polymer as binder.

5: The multilayer laminate according to claim 1, wherein the emulsion polymer is composed of at least 40% by weight of a C1 to C20 alkyl (meth)acrylate.

6: The multilayer laminate according to claim 1, wherein the wax layer c) is composed of a polyolefin wax.

7: The multilayer laminate according to claim 1, wherein said polyolefin wax is a polymer composed of at least 30% by weight of ethylene.

8: A method of producing a multilayer laminate according to claim 1, which comprises producing the pressure-sensitive adhesive layer by coating with an aqueous dispersion of pressure-sensitive adhesive and thereafter producing the wax layer by coating with an aqueous wax dispersion.

9: The method of producing a multilayer laminate according to claim 8, wherein the pressure-sensitive adhesive layer and the wax layer are produced wet on wet, wherein no drying is carried out after the coating of the dispersion of pressure-sensitive adhesive, which is followed immediately by coating with the wax dispersion.

10: The method according to claim 8, wherein the pressure-sensitive adhesive layer and the wax layer are applied continuously in one workstep to a backing in web form.

11: The method according to claim 10, wherein a multiple cascade die is used.

12: A multilayer laminate obtainable by a method according to claim 8.

13: The method of using the multilayer laminate according to claim 1 as a sealable component of a reclosable packaging system.

14: The method of using the multilayer laminate for packaging comestibles.

15: The method according to claim 13, wherein the laminate is sealable with polyethylene.

16: A method of packaging products which comprises using a multilayer laminate according to claim 1 to seal a tray which has a polyethylene seal layer.

17: The method according to claim 16, wherein the tray is composed of a thermoformed polyester film having a polyethylene seal layer.

18: The method according to claim 16 for packaging comestibles.

19: A reclosable pack obtainable using a laminate according to claim 1.

20: A reclosable pack obtainable by a method according to claim 16.
